(19) United States
(12) Patent Application Publication
(10) Pub. No.: US 2010/0209018 A1
(43) Pub. Date: Aug. 19, 2010

(54) Electronic Filing Cabinet

(76) Inventors: Christopher Alan Adkins, Lexington, KY (US); Stephen Porter Bush, Richmond, KY (US); Douglas Keith Peterson, JR., Irvine, KY (US); Timothy Lowel Strunk, Georgetown, KY (US); John Thomas Warren, JR., Lexington, KY (US); John Yeung Conway, Louisville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/389,043

(22) Filed: Feb. 19, 2009

(51) Int. Cl. G06K 9/60

(52) U.S. Cl. 382/306

(57) ABSTRACT

An image forming device including an electronic filing cabinet is provided. The electronic filing cabinet stores documents output from the image forming device or read into the image forming device. The electronic filing cabinet may include an optical character recognition unit, an indexing engine and a storage device. The optical character recognition unit scans or otherwise inspects the documents and generates timestamps for the documents. The scanned information is provided to the indexing engine. The indexing engine classifies and indexes the documents according to a first predefined set of rules. Thereafter, the indexed documents are stored in the storage device. A human machine interface is provided for updating the first predefined set of rules. Previously stored documents may also be retrieved through the human machine interface.

### BACKGROUND

1. Field of the Invention

The present invention relates to image forming devices. In particular, the present invention relates to an image forming device comprising an electronic filing cabinet for storing documents electronically.

2. Description of the Related Art

Typically, small office environments use a paper-filing cabinet to store important documents such as receipts and bills for subsequent reference. Documents that are printed, scanned or photocopied using image forming devices in offices are manually stored in the paper filing cabinet. Filing every document individually requires manual effort, which may be tedious for a user. Further, retrieval of previously stored documents for reference is difficult and time consuming.

In order to automate the paper filing process, some image forming devices are connected to a computer system. The computer system helps in archiving and retrieving relevant documents. In these systems, the image forming devices are not capable of storing documents independently. Therefore, transfer of archived documents to another computer system, which may be required for upgrading the computer system or replacing an old computer system, is difficult.

U.S. Pat. No. 6,957,235 titled ‘Automatic document archiving for a computer system’ assigned to Ricoh Corporation (NJ) and Ricoh Company Ltd. (JP) describes a method for archiving documents transferred between a computer system and a peripheral device. The documents are archived in the memory of the computer system. However, the method requires a computer system operating in conjunction with the peripheral device. Further, transfer of archived documents to another computer system is difficult.

### SUMMARY OF THE INVENTION

Embodiments of the present invention overcome shortcomings with prior systems and thereby satisfy a need to independently and automatically store documents and facilitate easy retrieval thereof.

An image forming device comprising an electronic filing cabinet is provided. The electronic filing cabinet includes an indexing engine and a storage device. The indexing engine further includes an optical character recognition unit. Documents output from the image forming device or read into the image forming device are processed by the optical character recognition unit. The optical character recognition unit scans and/or inspects the documents and generates timestamps for the documents. The scanned information and the generated timestamps are input into the indexing engine. Data about the operation, such as scan, fax and print, performed by the image forming device on the documents is also provided to the indexing engine. The indexing engine classifies and indexes the documents, based on the scanned information and a first predefined set of rules. The indexed documents are subsequently stored in the storage device based on a second predefined set of rules. The first predefined set of rules is provided by a user. Examples of the first predefined set of rules include potential actions based on the occurrence of predefined keywords, pattern recognition and document size. Potential actions may include classifying documents under predefined categories, sending an email to a predefined mailing account, deleting documents irrelevant or unimportant to a user, and the like. Examples of the second predefined set of rules may include document encryption, password protection and the like. The electronic filing cabinet also includes a human machine interface. Documents in the storage device may be retrieved by the user through a search engine integrated in the human machine interface.

Since the storage device is integrated in the image forming device, the image forming device can function independently and does not require a computer system. Further, the storage device may be removable for facilitating transfer of indexed documents to another image forming device. Moreover, the optical character recognition and indexing capabilities of the image forming device facilitate easy retrieval of documents for subsequent reference. In addition, electronic filing capabilities of the image forming device are not limited to a specific format of documents.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram of an image forming device, in accordance with an embodiment of the present invention; and

FIG. 2 is a flowchart depicting a method for indexing documents, in accordance with an embodiment of the present invention.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” or “comprising,” and variations thereof herein is meant to encompass the items listed thereafter and equivalents thereof as well as additional items. Unless limited otherwise, the terms “connected,” and “coupled,” and variations thereof herein are used broadly and encompass direct and indirect connections and couplings. In addition, the terms “connected” and “coupled” and variations thereof are not restricted to physical or mechanical connections or couplings.

The present invention relates to an electronic filing cabinet integrated in an image forming device for automatically and electronically storing documents that are produced as output from the image forming device or read into the image forming device. The documents are classified and indexed, and subsequently stored in a storage device. The indexed documents can be easily retrieved for reference, when required, by using keyword-based searching.

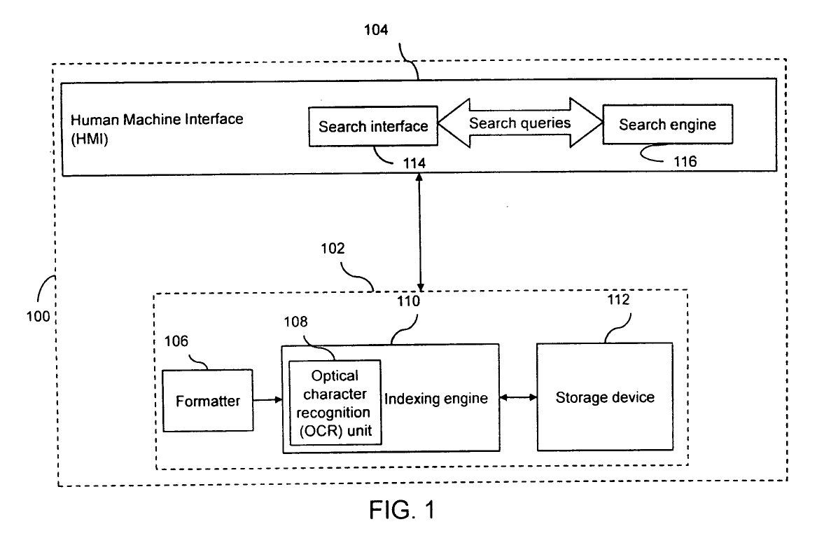

FIG. 1 is a block diagram of an image forming device 100, in accordance with an embodiment of the present invention. Image forming device 100 is a multi-function unit performing functions such as scan, fax, copy, and so forth. Image forming device 100 includes an electronic filing cabinet 102 and a human machine interface (HMI) 104. Electronic filing cabinet 102 includes a formatter 106, an indexing engine 110 and a storage device 112. Indexing engine 110 further includes an optical character recognition (OCR) unit 108. HMI 104 includes a search interface 114 and a search engine 116. In an embodiment of the present invention, HMI 104 is a control panel interface on image forming device 100. In this embodiment, HMI 104 comprises a control panel screen and a plurality of buttons for enabling user interaction. In another embodiment of the present invention, HMI 104 is a software application running on a computer (not shown) connected externally to image forming device 100.

It is understood that image forming device 100 may include other components and/or modules commonly found in imaging devices, such as a print engine, scan assembly and facsimile module (not shown).

Documents output from image forming device 100 or read into image forming device 100 are processed and subsequently stored in electronic filing cabinet 102. In an embodiment of the present invention, the processing and storage of documents is performed substantially automatically with little or no user input. Documents output from image forming device 100 include, but are not limited to, images of documents scanned, printed, faxed and copied by image forming device 100. Documents may, for example, be read into image forming device 100 through a memory device inserted in a USB interface, a pictbridge or a similar interface of image forming device 100. Documents may be output from or read into image forming device 100 through HMI 104.

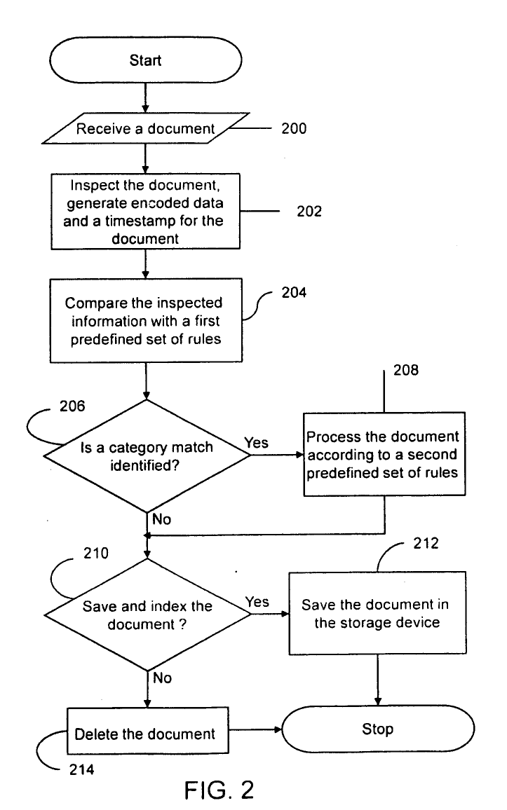

The documents processed by image forming device 100 are input into formatter 106. Formatter 106 converts the documents into an accessible format, for example, PDF before providing the documents as input to OCR 108. In an embodiment of the present invention, the documents may not be formatted. OCR 108 inspects and/or analyzes the documents and generates timestamps for the documents. Indexing engine 110 classifies and indexes the documents, based on the inspected information and/or the characters recognized by OCR 108 and a first predefined set of rules. Subsequently, indexing engine 110 stores the indexed documents in storage device 112 based on a second predefined set of rules. The method for indexing documents is described in detail in FIG. 2.

HMI 104 provides an interface for using image forming device 100 to perform print, scan, copy, fax and similar operations on a document. Further, HMI 104 facilitates retrieval of the indexed documents from storage device 112. Herein, search interface 114 and search engine 116 facilitate searching of the documents stored in storage device 112. In addition, the first predefined set of rules may be updated by a user through HMI 104.

Document inspecting by OCR 108 includes, but is not limited to, searching for predefined keywords in the documents, recognizing patterns and identifying document size. For example, a tax receipt that may have to be scanned by OCR 108 will have a particular format and size, and a tax receipt number printed on it. OCR 108 inspects the tax receipt for the keyword “tax”, the pattern of the tax receipt number and the size of the tax receipt. OCR 108 also generates encoded data about the operation performed on the documents by image forming device 100, such as scan, print and fax. In an embodiment of the present invention, OCR 108 functions independently of indexing engine 110.

In an embodiment of the present invention, indexing engine 110 is configured to receive emails from an FTP engine that can index files from a remote location. The emails may include information required to index the documents. The indexed documents are subsequently stored in storage device 112 based on the second predefined set of rules. In various embodiments of the present invention, storage device 112 may be a hard drive, a USB flash drive and a similar storage device that enables encrypted storage of the documents, based on the second predefined set of rules.

The first predefined set of rules may be directed to, but are not limited to, potential actions based on the occurrence of predefined keywords, pattern recognition and document size. The potential actions may include classifying documents under predefined categories, sending an email to a predefined mailing account, deletion of documents irrelevant or unimportant to a user, and the like. The second predefined set of rules may be directed to, but are not limited to, potential actions for handling or maintaining the classified, indexed documents, such as document encryption, password protection to control access, enabling remote access of documents, enabling a purging date or duration for the stored documents, and the like. In an embodiment of the present invention, categories of documents may possess certain default properties or actions defined by the user. In this embodiment, such default properties of categories may be included in the second predefined set of rules. For example, documents related to bank statements are categorized under a category “Bank”. This category may possess a default property of password protection. In other words, all the documents stored in storage device 112 related to bank statements are password protected.

The first predefined set of rules and the second predefined set of rules may be updated through HMI 104. HMI 104 also facilitates retrieval of previously stored documents. To retrieve documents, the user specifies the search criteria in the form of keywords through search interface 114. The search criteria are input into search engine 116 in the form of search queries. Search engine 116 identifies and retrieves documents desired by the user from storage device 112 through a data retrieval protocol. The retrieved documents may be further processed, for example, sent to an email account or printed, scanned, copied, or faxed by image forming device 100 through HMI 104.

For example, a user may require all the statements of his/her bank savings account from a predefined category “Bank” in the time period 2006-2008. The user may enter a keyword which refers to the name of the user's bank, the category as “Bank” and the time period as “2006-2008” as search criteria. The search engine performs a search in the specified category and identifies the documents that match the criteria. The documents identified under the category ‘Bank’ may be password protected and therefore require a password to be retrieved. Thereafter, the identified documents may be available for viewing, printing or email transmitting to a user-selected email account.

To enable speedy retrieval of the documents and reduce their storage size, storage device 112 may use compression techniques for compressing the indexed documents before storage. In various embodiments of the present invention, storage device 112 may be a combination of hardware, software and firmware that enables efficient storage, indexing and retrieval of documents. In various embodiments of the present invention, storage device 112 may facilitate up gradation of image forming device 100 by enabling transfer of archived documents to another image forming device. In an embodiment of the present invention, storage device 112 is removable for enabling transfer of the indexed documents from image forming device 100 to another image forming device. In another embodiment of the present invention, data transfer may be achieved by facilitating transfer of indexed documents from storage device 112 to a computer, to buffer data to be transferred to another image forming device. In another embodiment of the present invention, data transfer may be achieved via a portable memory device. In yet another embodiment of the present invention, data transfer may be achieved via a network connection, such as a wireless connection.

The scanning and indexing operations automatically performed on the documents before storage in storage device 112 are explained in conjunction with FIG. 2. FIG. 2 is a flowchart depicting a method for indexing, in accordance with an embodiment of the present invention.

With reference to FIGS. 1 and 2, a document is received at indexing engine 110 as input at step 200. The received document may have been output from image forming device 100 or read into image forming device 100. At step 202, after being formatted by formatter 106, the document is inspected by OCR 108 for predefined keywords, patterns, document size and similar features set by the user. OCR 108 also generates a timestamp for the document and encoded data about the operation performed on the document such as print or fax. At step 204, indexing engine 110 compares the inspected information with a first predefined set of rules. At step 206, indexing engine 110 determines whether the document can be mapped on to an existing category, by comparing the inspected document with the first set of predefined rules. If a suitable category match is identified, the document is processed according to the second predefined set of rules at step 208. Document processing may include encryption, enabling password protection, enabling remote access, sending an email to a predefined mailing account, and the like. If a category match is not identified or the inspected information maps to multiple categories, the saving and indexing preferences for the document are checked at step 210. The saving and indexing preferences for the document may be determined from the first and the second predefined set of rules. The saving and indexing preferences may also be provided by the user at runtime through HMI 104. Herein, the document may also be categorized at runtime. Accordingly, if the document needs to be indexed and saved, it is indexed and stored in storage device 112 at step 212. If the document does not need to be stored, it is deleted at step 214 and is no longer maintained in image forming device 100.

The method and system described above are explained in conjunction with the following example. A user scans a set of tax receipts for the time period 2006 to 2008 using image forming device 100. The set of scanned tax receipts is received as input at indexing engine 110. The set of scanned tax receipts includes a keyword “tax”, a pattern listing the tax receipt number, and has a predefined size. OCR 108 inspects and/or analyzes the set of tax receipts, and also generates a timestamp and encoded data about the “scan” operation. The inspected information along with the generated timestamp and encoded data is provided to indexing engine 110. The scanned information is compared with the first predefined set of rules. According to the first predefined set of rules, the set of tax receipts is classified under the category “tax”. Further, according to the second predefined set of rules, the set of tax receipts is encrypted. Thereafter, the saving and indexing preferences for the set of tax receipts are determined. Accordingly, the set of tax receipts is saved in storage device 112 under the “tax” category. The set of tax receipts may then be retrieved by a user by using keywords such as “tax”. On retrieval, the set of tax receipts is decrypted.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An image forming device comprising an electronic filing cabinet for archiving documents output from the image forming device or read into the image forming device, the electronic filing cabinet comprising:
an indexing engine for recognizing characters and patterns in a document, generating a timestamp therefore, and classifying and indexing the document based upon the recognized characters and patterns and a first predefined set of rules; and
a storage device for storing the indexed document based on a second predefined set of rules.

2. The image forming device according to claim 1 wherein the storage device facilitates up gradation of the image forming device.

3. The image forming device according to claim 1 further comprising a human machine interface coupled to the electronic filing cabinet for enabling a user to manage the first predefined set of rules for indexing the document.

4. The image forming device according to claim 3 wherein the human machine interface further comprises a search engine for retrieving the indexed document.

5. The image forming device according to claim 1 wherein the electronic filing cabinet further comprises a formatter for converting the document to an accessible format for storage in the storage device.

6. The image forming device according to claim 1, wherein the indexing engine selectively stores the document in the storage device based upon the recognized characters therein and the first predefined set of rules.

7. A method for archiving documents output from an image forming device or read into the image forming device, the method comprising:
recognizing particular characters in the document;
generating timestamps for the documents corresponding to a time of receipt or generation thereof;
classifying the documents based on one or more particular characters recognized and a first predefined set of rules;
indexing the documents based on the classification; and
selectively storing the indexed documents based on a second predefined set of rules.

8. The method according to claim 7 further comprising receiving updates of the first predefined set of rules and the second predefined set of rules.

9. The method according to claim 7 further comprising retrieving the indexed documents.

10. The method according to claim 9 further comprising treating the retrieved documents as inputs to the image forming device.

11. The method according to claim 7 further comprising converting the documents to an accessible format before storing the documents.

12. The method according to claim 7 further comprising selectively refraining from storing an indexed document based upon the first predefined set of rules and one or more characters recognized.

13. The method according to claim 7 further comprising transferring the stored documents from the image forming device to a second image forming device, wherein the transfer facilitates up gradation of the image forming device.

14. A computer program product for archiving documents output from an image forming device or read into the image forming device, the computer program product including instructions stored on a medium and executed by the image forming device, the computer program comprising:
program instructions for recognizing characters in the documents;
program instructions for generating timestamps for the documents;
program instructions for classifying the documents based on one or more recognized characters and a first predefined set of rules;
program instructions for indexing the documents based on the classification; and
program instructions for selectively storing the indexed documents according to a second predefined set of rules.

15. The computer program product according to claim 14 further comprising program instructions for retrieving the indexed documents.

16. The computer program product according to claim 14, further comprising instructions for selectively refraining from storing an indexed document according to at least one recognized character and the first predefined set of rules.
